(19) United States
(12) Patent Application Publication
(10) Pub. No.: US 2008/0157600 A1
(43) Pub. Date: Jul. 3, 2008

(54) Operator interface for an electric power generation system

(75) Inventors: Alyssa Marlenee, Minneapolis, MN (US); Raphael T. Scherer, South Bloomington, MN (US); Mitchell E. Peterson, Maple Grove, MN (US); Ed Pickens, New Brighton, MN (US)

Correspondence Address: KRIEG DEVAULT LLP, ONE INDIANA SQUARE, SUITE 2800, INDIANAPOLIS, IN, 46204-2079, US

(73) Assignee: Cummins Power Generation IP, Inc.

(21) Appl. No.: 11/807,420

(22) Filed: May 29, 2007

Related U.S. Application Data
(60) Provisional application No. 60/877,758, filed on Dec. 29, 2006.

(51) Int. Cl. H02J 9/00

(52) U.S. Cl. 307/66; 307/64

(57) ABSTRACT

A mobile electric power generation system includes a variable speed generator, an engine to drive the generator, a DC bus coupled to the generator, an inverter coupled between the DC bus and an electrical power bus in the vehicle, an electrical energy storage device coupled to the DC bus, an operator interface including a display and several operator input devices, and operating logic executed by a processor. One operator input device is used to initiate an automatic mode of operation of the system. The operating logic is structured to activate both the generator and the inverter during the automatic mode. Another operator input device is selected to initiate a manual mode of operation. The operating logic is responsive to one input to change activation of the generator and to another to change activation of the inverter.

### CROSS-REFERENCE TO RELATED APPLICATIONS

The present application claims the benefit of U.S. Provisional Patent Application No. 60/877,758 filed on 29 Dec. 2006 which is hereby incorporated by reference in its entirety.

### BACKGROUND

The present invention relates to electric power generation, and more particularly, but not exclusively, relates to an operator interface for a vehicle-carried electric power generation system.

In certain applications, a power system is installed in a vehicle that includes a dedicated engine/generator set and electrical energy storage device, and sometimes a transfer power switch to alternatively source power from an external source (sometimes called “shore power”). In most current applications, the engine/generator set, the electrical energy storage device, and transfer power switch subsystems come from independent sources and tend to work independent of one another. Unfortunately, the ability to desirably integrate and collectively manage operation of such subsystems can be challenging - typically presenting a baffling array of operator input/output controls. Indeed, there is an ongoing demand for further contributions in this area of technology.

### SUMMARY

One embodiment of the present invention includes a unique technique involving electric power generation. Other embodiments include unique methods, devices, and apparatus relating to an operator interface for an electric power generation system. Further embodiments, forms, features, aspects, benefits, and advantages of the present application shall become apparent from the description and figures provided herewith.

### BRIEF DESCRIPTION OF THE DRAWING

FIG. 1 is a diagrammatic view of a vehicle carrying an electric power generation system.

FIG. 2 is a schematic view of circuitry included in the system of FIG. 1.

FIG. 3 is a control flow diagram for the circuitry of FIG. 2.

FIG. 4 is a flowchart of one procedure for operating the system of FIG. 1.

FIG. 5 is a front view of an operator interface panel for the system of FIG. 1 that includes a display device, several status indicators, and several operator input devices.

FIGS. 6-11 are state logic diagrams relating to the operation of the operator interface panel device of FIG. 5.

### DETAILED DESCRIPTION OF REPRESENTATIVE EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

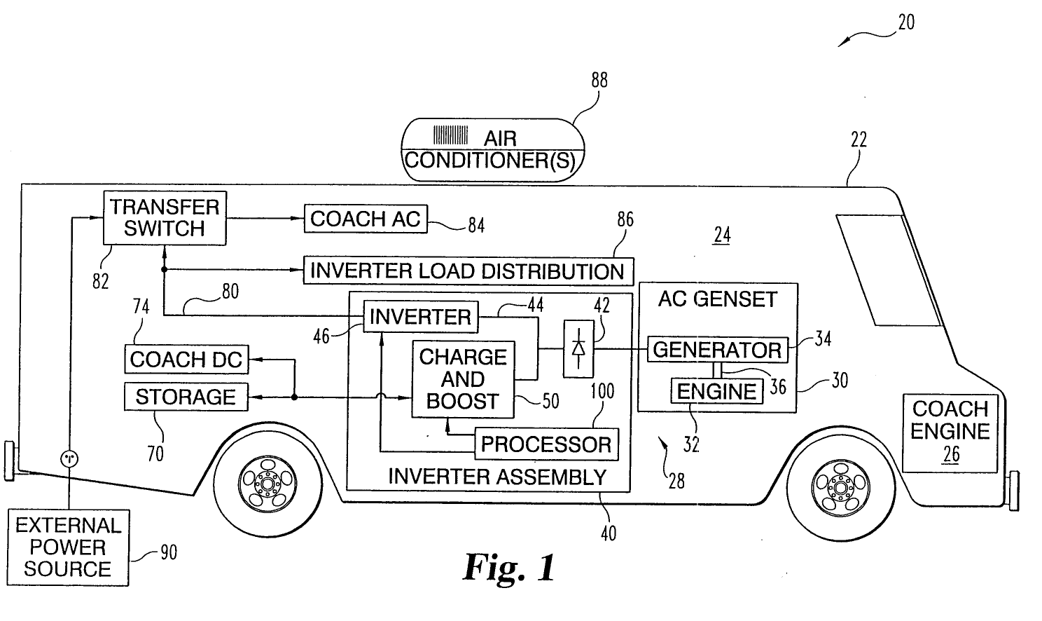

FIG. 1 illustrates vehicle 20 in the form of a motor coach 22. Motor coach 22 includes interior living space 24 and is propelled by coach engine 26. Coach engine 26 is typically of a reciprocating piston, internal combustion type. To complement living space 24, coach 26 carries various types of electrical equipment 27, such as one or more air conditioner(s) 88. Equipment 27 may further include lighting, kitchen appliances, entertainment devices, and/or such different devices as would occur to those skilled in the art. Coach 22 carries mobile electric power generation system 28 to selectively provide electricity to equipment 27. Correspondingly, equipment 27 electrically loads system 28. In one form, various components of system 28 are distributed throughout vehicle 20—being installed in various bays and/or other dedicated spaces.

System 28 includes two primary sources of power: Alternating Current (AC) power from genset 30 and Direct Current (DC) power from electrical energy storage device 70. Genset 30 includes a dedicated engine 32 and three-phase AC generator 34. Engine 32 provides rotational mechanical power to generator 34 with rotary drive member 36. In one arrangement, engine 32 is of a reciprocating piston type that directly drives generator 34, and generator 34 is of a permanent magnet alternator (PMA) type mounted to member 36, with member 36 being in the form of a drive shaft of engine 32. In other forms, generator 34 can be mechanically coupled to engine 32 by a mechanical linkage that provides a desired turn ratio, a torque converter, a transmission, and/or a different form of rotary linking mechanism as would occur to those skilled in the art. Operation of engine 32 is regulated via an Engine Control Module (ECM) (not shown) that is in turn responsive to control signals from control and inverter assembly 40 of system 28.

The rotational operating speed of engine 32, and correspondingly rotational speed of generator 34 varies over a selected operating range in response to changes in electrical loading of system 28. Over this range, genset rotational speed increases to meet larger power demands concomitant with an increasing electrical load on system 28. Genset 30 has a steady state minimum speed at the lower extreme of this speed range corresponding to low power output and a steady state maximum speed at the upper extreme of this speed range corresponding to high power output. As the speed of genset 30 varies, its three-phase electrical output varies in terms of AC frequency and voltage.

Genset 30 is electrically coupled to assembly 40. Assembly 40 includes power control circuitry 40a to manage the electrical power generated and stored with system 28. Circuitry 40a includes three-phase rectifier 42, variable voltage DC power bus 44, DC-to-AC power inverter 46, charge and boost circuitry 50, and processor 100. Assembly 40 is coupled to storage device 70 to selectively charge it in certain operating modes and supply electrical energy from it in other operating modes via circuitry 50 as further described hereinafter. Assembly 40 provides DC electric power to the storage device one or more motor coach DC loads 74 with circuitry 50 and provides regulated AC electric power with inverter 46. AC electric loads are supplied via inverter AC output bus 80. Bus 80 is coupled to AC power transfer switch 82 of system 28. One or more coach AC electrical loads 84 are supplied via switch 82. System 28 also provides inverter load distribution 86 from bus 80 without switch 82 intervening therebetween.

As shown in FIG. 1, switch 82 is electrically coupled to external AC electrical power source 90 (shore power). It should be appreciated that shore power generally cannot be used when vehicle 20 is in motion, may not be available in some locations; and even if available, shore power is typically limited by a circuit breaker or fuse. When power from source 90 is applied, genset 30 is usually not active. Transfer switch 82 routes the shore power to service loads 84, and those supplied by inverter load distribution 86. With the supply of external AC power from source 90, assembly 40 selectively functions as one of loads 84, converting the AC shore power to a form suitable to charge storage device 70. In the following description, AC shore power should be understood to be absent unless expressly indicated to the contrary. It should be appreciated that generator 34 of genset 30, assembly 40 (including rectifier 42, bus 44, and inverter 46), charge and boost circuitry 50, device 70, and switch 82 collectively comprise a group of system power components 98.

Assembly 40 further includes processor 100. Processor 100 executes operating logic that defines various control, management, and/or regulation functions. This operating logic may be in the form of dedicated hardware, such as a hardwired state machine, programming instructions, and/or a different form as would occur to those skilled in the art. Processor 100 may be provided as a single component, or a collection of operatively coupled components; and may be comprised of digital circuitry, analog circuitry, or a hybrid combination of both of these types. When of a multi-component form, processor 100 may have one or more components remotely located relative to the others. Processor 100 can include multiple processing units arranged to operate independently, in a pipeline processing arrangement, in a parallel processing arrangement, and/or such different arrangement as would occur to those skilled in the art. In one embodiment, processor 100 is a programmable microprocessing device of a solid-state, integrated circuit type that includes one or more processing units and memory. Processor 100 can include one or more signal conditioners, modulators, demodulators, Arithmetic Logic Units (ALUs), Central Processing Units (CPUs), limiters, oscillators, control clocks, amplifiers, signal conditioners, filters, format converters, communication ports, clamps, delay devices, memory devices, and/or different circuitry or functional components as would occur to those skilled in the art to perform the desired communications. In one form, processor 100 includes a computer network interface to facilitate communications the using the industry standard Controller Area Network (CAN) communications among various system components and/or components not included in the depicted system, as desired.

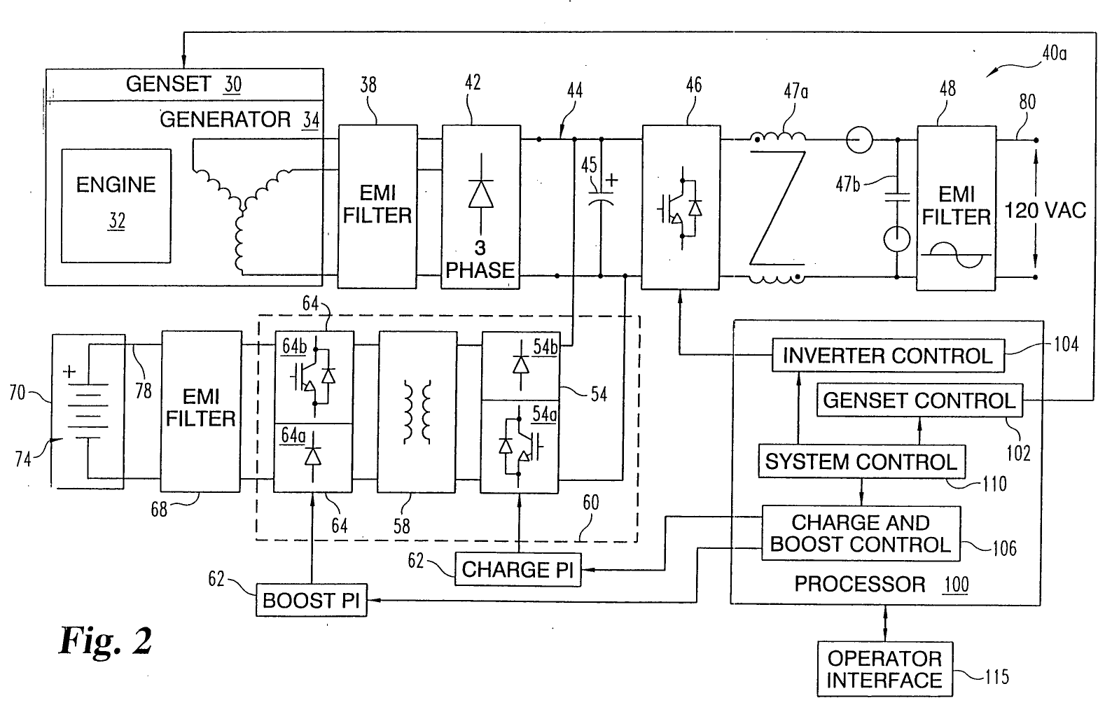

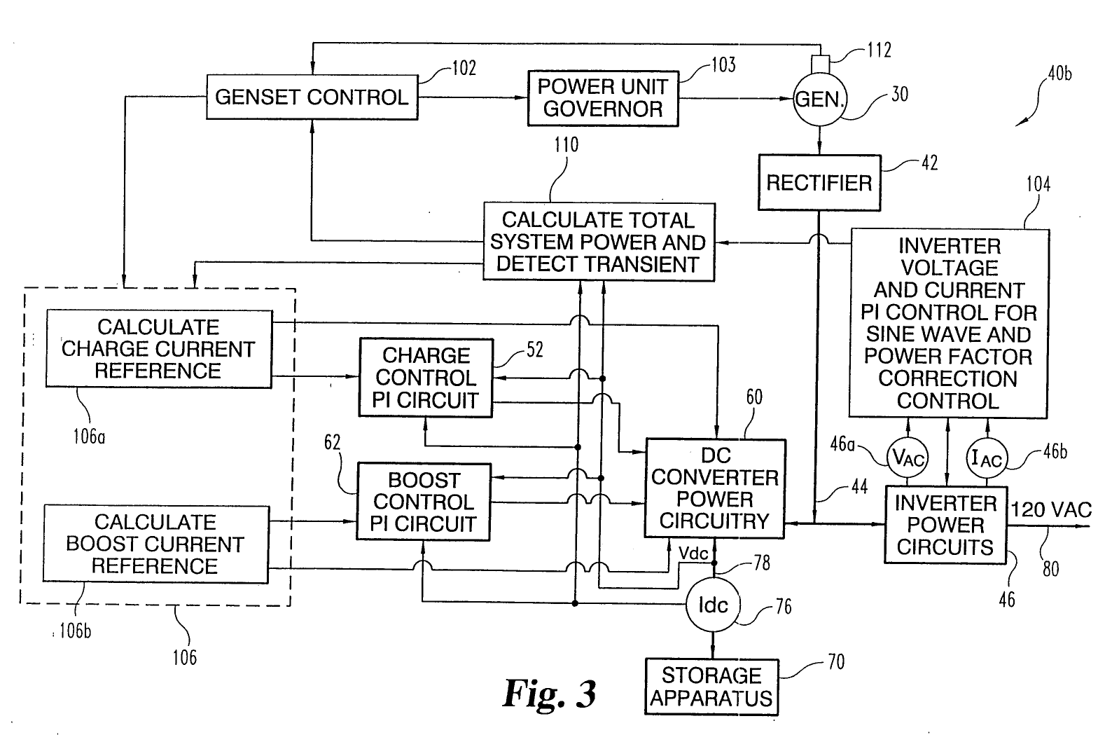

Referring additionally to the schematic circuit view of FIG. 2 and the control flow diagram of FIG. 3, selected aspects of system 28 are further illustrated; where like reference numerals refer to like features previously described. In FIG. 3, blocks formed with heavier line weighting correspond to hardware-implemented functionality, and blocks formed with lighter line weighting correspond to software-implemented functionality provided by programming of processor 100. Assembly 40 includes Electromagnetic Interference (EMI) filter 38 coupled to three-phase rectifier 42. In one form, rectifier 42 is implemented with a standard six diode configuration applicable to three-phase AC-to-DC conversion. Rectifier 42 receives the EMI-filtered, three-phase AC electric power output from genset 30 when genset 30 is operational. Filter 38 removes certain time varying characteristics from the genset output that may result in undesirable inference and rectifier 42 converts the filtered three-phase AC electric power from genset 30 to a corresponding DC voltage on bus 44.

At least one capacitor 45 is coupled across DC bus 44 to reduce residual “ripple” and/or other time varying components. The DC voltage on bus 44 is converted to an AC voltage by inverter 46 in response to inverter control logic 104 of processor 100. In one form, inverter 46 is of a standard H-bridge configuration with four Insulated Gate Bipolar Transistors (IGBTs) that is controlled by Pulse Width Modulated (PWM) signals from processor 100. In other forms, inverter 46 can be comprised of one or more other switch types such as field effect transistors (FETs), gated thyristors, silicon controlled rectifiers (SCRs), or the like. The PWM control signals from logic 104 selectively and individually drive the gates/switches of inverter 46. Typically, these control signals are input to intervening power drive circuitry coupled to inverter gates, and the control signals are isolated by opto-isolators, isolation transformers, or the like. Inverter control logic 104 includes a Proportional-Integral (PI) controller to synthesize an approximate sinusoidal AC waveform. Sensing arrangement 45 includes AC voltage sensor 46a and AC current sensor 46b. Inverter control logic 104 receives AC voltage (VAC) from voltage sensor 46a and AC current (IAC) from current sensor 46b that correspond to the power delivered to bus 80 from inverter 46. The VAC and IAC inputs to logic 104 are utilized as feedback to generate the sinusoidal waveform for the output power with a PI controller. In addition, these inputs are used to calculate power properties required to control sharing functions for the overall system determine the power factor for the sinusoidal voltage and current outputs to facilitate power factor correction via a PI controller. System control logic 110 receives AC power output information from inverter control logic 104. This information can be used to determine system power, and is used to compare with the power delivery capacity of genset 30 and device 70 to regulate certain operations described hereinafter. Furthermore, logic 110 uses this AC output information to determine whether a transient power condition exists that warrants consideration in such operations. Operator interface 115 of FIG. 2 is operatively coupled to processor 100 to provide operator input (I/P) and output (O/P) or “I/O” as more fully described in connection with FIGS. 5-11.

Inductor 47a and capacitor 47b provide further filtering and conversion of the inverter 46 output to a desired AC power waveform. EMI filter 48 provides interference filtering of the resulting AC power waveform to provide a regulated single-phase AC power output on bus 80. In one nonlimiting example, a nominal 120 VAC, 60 Hertz (Hz) output is provided on bus 80, the genset three-phase output to rectifier 42 varies over a voltage range of 150-250 volts AC (VAC) and a frequency range of 200-400 Hertz (Hz), and the variable voltage on DC bus 44 is between 200 and 300 volts DC (Vdc)

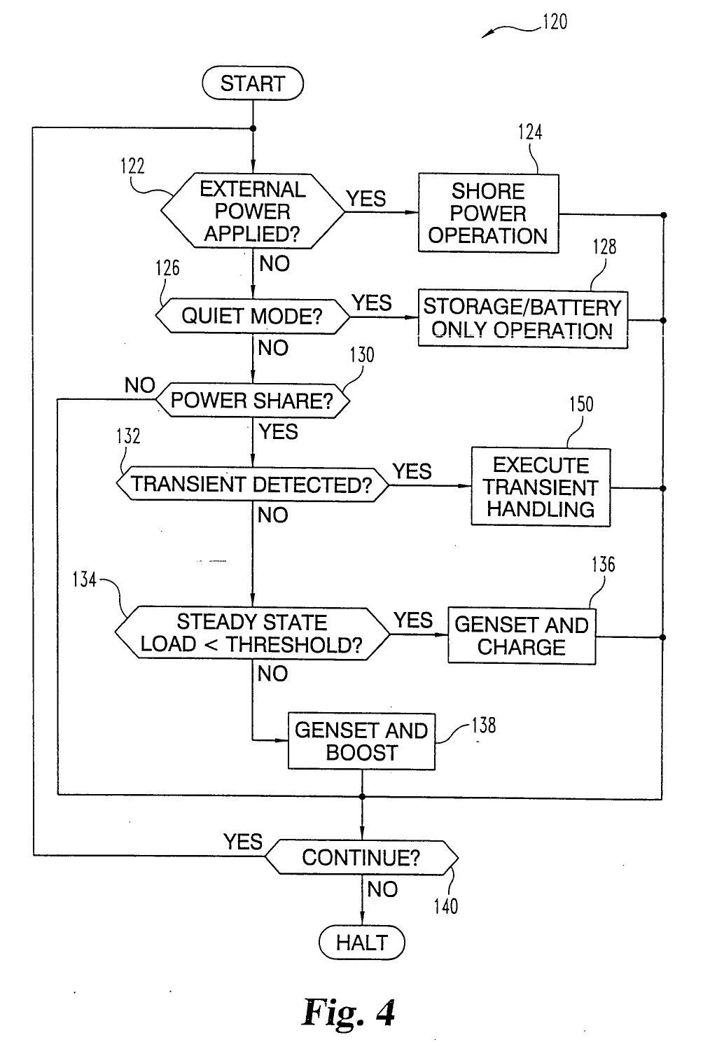

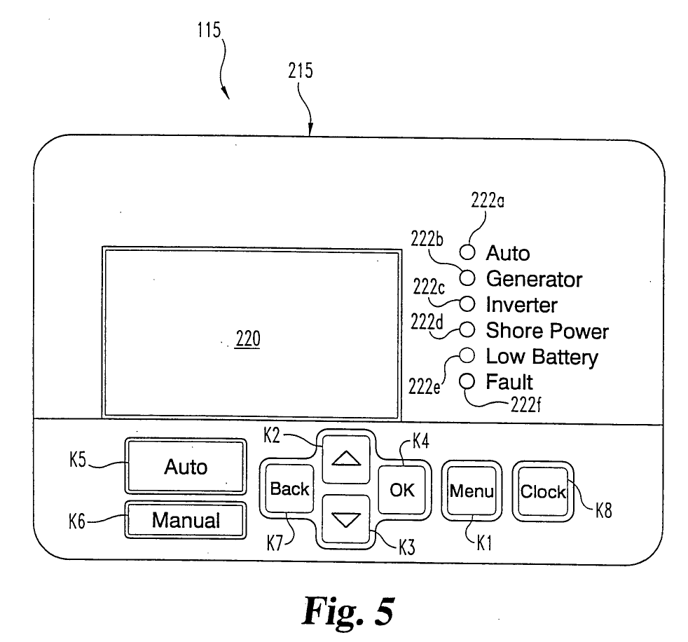

In addition to inverter control logic 104, processor 100 includes genset power request control logic 102 to regulate rotational speed of genset 30 relative to system 28 operations. Logic 102 provides input signals to genset 30 that are representative of a requested target load to be powered by genset 30. Genset governor 103 of genset 30 responds to logic 102 to adjust engine rotational speed, which in turn adjusts rotational speed of generator 34. Control by logic 102 is provided in such a manner that results in different rates of genset speed change (acceleration/deceleration) depending on one or more conditions (like transients), as more fully explained in connection with FIG. 4 hereinafter.

In one particular form, governor 103 is implemented in an Engine Control Module (ECM) included with genset 30 that communicates with processor 100 over a CAN interface. Alternatively or additionally, at least a portion of governor 103 can be included in assembly 40. Speed control logic 102 is responsive to system control logic 110 included in the operating logic of processor 100, and an engine speed feedback signal provided by engine speed sensor 112. Speed adjustment with logic 102 can arise with changes in electrical loading and/or charge or boost operations of device 70, as further described hereinafter. In turn, logic 102 provides control inputs to charge and power boost control logic 106.

Controllable DC-to-DC converter 60 is electrically coupled to DC bus 44 and electrical energy storage device 70. In FIG. 2, device 70 is more specifically illustrated in the form of electrochemical battery device 75 as shown in FIG. 2. Electrical current flow between device 70 and converter 60 is monitored with current sensor 76 and DC voltage of device 70 is monitored at node 78. In one embodiment, more than one current sensor and/or current sensor type may be used (not shown). For example, in one arrangement, one sensor may be used to monitor current of device 70 for power management purposes (such as a Hall effect sensor type), and another sensor may be used in monitoring various charging states (such as a shunt type). In other embodiments, more or fewer sensors and/or sensor types may be utilized.

Converter 60 provides for the bidirectional transfer of electrical power between DC bus 44 and device 70. Converter 60 is used to charge device 70 with power from DC bus 44, and to supplement (boost) power made available to DC bus 44 to service power demand on bus 80. Converter 60 includes DC bus interface circuitry 54 and storage interface circuitry 64 under the control of charge and power boost control logic 106. Bus interface circuitry 54 includes a charge inverter 54a and power boost rectifier 54b. Storage interface circuitry 64 includes charge rectifier 64a and power boost inverter 64b. Transformer 58 is coupled between circuitry 54 and circuitry 64. Charge inverter 54a and boost inverter 64b can be of an H-bridge type based on IGBTs, FETs (including MOSFET type), gated thyristors, SCRs, or such other suitable gates/switching devices as would occur to those skilled in the art. Further, while rectifiers 54b and 64a are each represented as being distinct from the corresponding inverter 54a or 64b, in other embodiments one or more of rectifiers 54b and 64a can be provided in the form of a full wave type comprised of the protective “free wheeling” diodes electrically coupled across the outputs of the respective inverter 54a or 64b component. For rectifier operation of this arrangement, the corresponding inverter components are held inactive to be rendered nonconductive.

Charge Proportional-Integral (PI) control circuit 52 is electrically coupled to charge inverter 54a and power boost PI control circuit 62 is electrically coupled to power boost inverter 64b. Circuits 52 and 62 each receive respective charge and boost current references 106a and 106b as inputs. Electrical current references 106a and 106b are calculated by charge and power boost control logic 106 with processor 100. These references are determined as a function of power demand, system power available, and the presence of any transient power conditions. The total system power is in turn provided as a function of the power provided by inverter 46 to bus 80 (inverter power), the power-generating capacity of genset 30, and the power output capacity of device 70. The inverter power corresponds to the AC electrical load “power demand” as indicated by the VAC voltage, IAC current, and corresponding power factor that results from electrical loading of bus 80. The genset power-generating capacity is determined with reference to genset power/load requested by logic 102. When the power demand on bus 80 can be supplied by genset 30 with surplus capacity, then this surplus can be used for charging device 70 by regulating converter 60 with PI control circuit 52; and when the power demand exceeds genset 30 capacity, supplemental power can be provided to bus 80 from device 70 by regulating converter 60 with PI control circuit 62. Various aspects of dynamic “power sharing” operations of system 28 are further described in connection with FIG. 4 hereinafter; however, further aspects of converter 60 and its operation is first described as follows.

Converter 60 is controlled with system control logic 110 to enable/disable charge and boost operations. Under control of logic 110, the charge mode of operation and the boost mode of operation are mutually exclusive—that is they are not enabled at the same time. When charge mode is enabled, the electrochemical battery form of device 70 is charged in accordance with one of several different modes depending on its charging stage. These charging stages may be of a standard type and may be implemented in hardware, software, or a combination thereof. In one form, a three-stage approach includes bulk, absorption, and float charging. When charging, circuit 52 outputs PWM control signals that drive gates of charge inverter 54a in a standard manner. Typically, the PWM control signals are input to standard power drive circuitry (not shown) coupled to each gate input, and may be isolated therefrom by optoisolators, isolation transformers, or the like. In response to the PWM input control signals, inverter 54a converts DC power from DC bus 44 to an AC form that is provided to rectifier 64a of circuitry 64 via transformer 58. Rectifier 64a converts the AC power from transformer 58 to a suitable DC form to charge battery device 75. In one form directed to a nominal 12 Vdc output of battery device 75, transformer 58 steps down the AC voltage output by inverter 54a to a lower level suitable for charging storage device 70. For nonbattery types of devices 70, recharging/energy storage in the “charge mode” is correspondingly adapted as appropriate.

When power boost mode is enabled, boost PI control circuit 62 provides PWM control signals to boost inverter 64b to control the power delivered from device 70. The circuit 62 output is in the form of PWM control signals that drive gates of boost converter 64b in a standard manner for a transformer boost configuration. Typically, these control signals are input to power drive circuitry (not shown) with appropriate isolation if required or desired. When supplementing power provided by generator 32, a current-controlled power boosting technique is implemented with circuit 62. Circuit 62 provides proportional-integral output adjustments in response the difference between two inputs: (1) boost current reference 106b and (2) storage device 70 current detected with current sensor 76. In response, inverter 64b converts DC power from device 70 to an AC form that is provided to rectifier 54b of circuitry 54 via transformer 58. Rectifier 64b converts the AC power from transformer 58 to a suitable DC form for DC bus 44. In one form directed to a nominal 12 Vdc output of device 70, transformer 58 steps up the AC voltage output from inverter 64b, that is converted back to DC power for bus 44.

It should be appreciated that the DC voltage on DC bus 44 is variable rather than regulated. The variation in voltage on DC 44 as AC power is supplied to bus 80 extends over a wide range as the speed of genset 30 and/or the boost power from or charge power to device 70 varies. In one preferred embodiment, the lower extreme of this range is at least 75% of the upper extreme of this range while providing power to electrical loads on bus 80. In a more preferred form, the lower extreme is at least 66% of the upper extreme. In an even more preferred form, the lower extreme is at least 50% of the upper extreme.

FIG. 4 depicts power management process 120 for system 28 that is performed in accordance with operating logic executed by processor 100. Also referring to FIGS. 1-3, process 120 begins with conditional 122 that tests whether shore power from external source 90 is being applied. If the test of conditional 122 is true (yes) then shore power operation 124 is performed. In operation 124, shore power is applied from bus 80 to charge apparatus 170. The AC shore power from bus 80 uses inductor 47a and circuit 46 to provide power factor correction, and is rectified through protective “free wheeling” diodes electrically coupled across each gate of inverter 46. The resulting DC voltage on bus 44 is regulated to a relatively constant value to the extent that the magnitude of the AC shore power on bus 80 remains constant. This DC voltage, as derived from shore power, is provided to converter 60 to charge battery 76. During operation 124, shore power is also provided to coach AC loads 84, to loads of inverter distribution 86 through transfer switch 82, and to coach DC loads 74.

If the test of conditional 122 is false (no), process 120 continues with conditional 126. Conditional 126 tests whether system 28 is operating in a quite mode. If the test of conditional 126 is true (yes), then the storage/battery only operation 128 is performed. Quite mode is typically utilized when the noise level resulting from the operation of genset 30 is not permitted or otherwise not desired and when shore power is not available or otherwise provided. Correspondingly, in operation 128 genset 30 is inactive, and power is provided only from storage device 70. For operation in this quiet mode, power delivered by storage device 70 is voltage-controlled rather than current-controlled, supplying a generally constant voltage to DC bus 44 to facilitate delivery of an approximately constant AC voltage on bus 80 of assembly 40. In one form, the AC power sourced from assembly 40 is only provided to loads for inverter distribution 86, with switch 82 being configured to prevent power distribution to coach AC loads 84. DC coach loads 74 are also serviced during operation 128.

If the test of conditional 126 is false (no), then conditional 130 is encountered. Conditional 130 tests whether power share mode is active. In response to changes in electrical loading of system 28, the power share mode dynamically adjusts the speed of genset 30 and boost/charge operations based on total power capacity and transient status of system 28. It should be appreciated that total power accounts for: (a) ac power output from inverter 46 as measured by inverter voltage and current, (b) the dc power as measured at the storage device, and (c) the power loss intrinsic to inverter assembly 40. The loss calculation facilitates determination of a target genset speed and boost rate for steady state operation, as further discussed in connection with operation 138.

If the test of conditional 130 is true (yes), then conditional 132 is executed. Conditional 132 tests whether a power level change or transient has been detected during operation in the power share mode. If the test of conditional 132 is true (yes), then transient handling operation 150 is performed. In one form, several different types of transient conditions are identified and are handled with different responses appropriate to the type. For example, the largest load change indicative of multiple air conditioner start-up is detected the most quickly (in a fraction of power cycle) and corresponds to the quickest response by disabling device 70 charging and maximizing boost from device 70 and acceleration of genset 30. Other load changes that at least initially exceed the power available are detected by evaluation of more than one cycle and are further distinguished between initially resistive loads and a single air conditioner start-up that initially is inductive. In contrast to the resistive load type, it has been found that for the single air conditioner start-up the speed increase of the genset 30 can be limited to a rate somewhat less than its maximum acceleration level. This rate can be selected to reduce human perception of a speed change, with the balance of any power demand being dynamically met by boost from device 70. This technique can also be used for lesser transients. Still another type of lesser transient can be addressed by reducing charge level or switching from charge to boost with a controlled change in the speed of the genset 30.

If the test of conditional 132 is false (no), then the power is at steady state in the power share mode. Steady state power delivery occurs in one of two ways contingent on the steady state electrical load magnitude. Conditional 134 implements this contingency. Conditional 134 tests whether the electrical load is below a selected threshold related to available genset 30 power (steady state genset rating). This test involves adding the dc and ac power levels, accounting for losses, and comparing the total power to the genset power rating to determine if simultaneous charging of device 70 can be performed. If so, the test of conditional 134 is true (yes) and operation 136 is performed.

In operation 136, a “genset plus charge” power share mode is supported that uses excess genset capacity for charging device 70, as needed (charge enabled/boost disabled). The genset plus charge power share mode of operation 136 typically reaches steady state from a transient condition. The total genset power in the genset plus charge mode is determined as the measured ac power output plus the measured dc charging power less estimated charger losses. In one form, the charger loss is estimated by reference to one or more tables containing the loss of the charger circuitry as a function of battery voltage and charge current. The target genset speed is then determined based on the normalized load calculated by the above method. The genset speed is set to support the dc and ac loads. When the genset reaches the rated charge level, its speed may be reduced. As the ac power requirement approaches the genset rating, the charge rate may be reduced in order to maintain load support with genset 30.

If the test of conditional 134 is false (no), then operation 138 results. In operation 138, genset 30 and device 70 are both utilized to provide power to the electrical load at steady state in a “genset plus boost” power share mode. The desired boost rate is calculated based on total ac and dc power requirements less loss. This boost rate controls boost current to reach the desired power share between the genset and the storage device. The boost rate is calculated by determining the desired storage power contribution to the system load and referencing one or more tables that represent the loss of boost circuitry as a function of battery voltage and current. Typically, for this steady state condition, genset 30 is operating at an upper speed limit with additional power being provided from device 70 in the boost enabled mode. It should be understood that this genset plus boost power share operation also typically reaches steady state from a transient condition after execution of operation 150. In one form, the load calculations are normalized to a percent system rating, a percent boost capability, and a percent genset load to facilitate system scaling for different genset and boost sizes. By way of nonlimiting example, a few representative implementations include a 7.5 kW genset and 2.5 kW boost for a total of 10 kW, a 5.5 kW genset and 2.5 kW boost for a total of 8 kW, and 12 kW genset and 3 kW boost for a total of 15 kW, and a 12 kW genset and 6 kW boost for a total of 18 kW. Naturally, in other embodiments, different configurations may be utilized.

Operator interface 115 is operatively connected to processor 100 to provide various operator inputs to system 28 and output status information. Referring to FIG. 5, interface 115 is illustrated in the form of an interface panel that is mounted in vehicle 20 to provide appropriate operator input/output (I/O) with respect to system 20 operation. As depicted, interface 115 includes a graphic display device 215, indicators 222a-222f, and operator input devices 224. As illustrated, display device 215 is of an LCD type that facilitates display of multiple lines of alphanumeric information, graphic symbols, or the like; and optionally includes backlighting; however, in other embodiments a different type of display and/or more or fewer displays may be utilized. As depicted, indicators 222a-222d are a type of Light Emitting Diode (LED) with green coloration to indicate the status of certain aspects of the operation of system 20 as further described hereinafter, indicator 222e is an LED with yellow coloration that is lit when the charge level of device 70 falls below a desired level, and indicator 222f is an indicator with red color that is lit when a fault is detected. In other embodiments, some or all of indicators 222a-222f may be of a different type, may be absent or may include one or more other types of indicators, such as incandescent lamps, electromechanically actuated indicators, audible indicators, or the like.

Operator input devices 224 are each in the form of a membrane push button key, more specifically designated as operator keys K1-K8. Each of keys K1-K8 has a corresponding input function associated therewith. Key K1 activates and de-activates menus. Key K2 scrolls upward. Key K3 scrolls downward. Key K4 is the “OK” key and is used to select or enter information. Key K5 initiates a dedicated automatic (auto) mode. Key K6 initiates a dedicated manual mode. Key K7 displays the previous screen or menu. Key K8 toggles a clock display screen. In other embodiments, more or fewer devices 224 and/or a different type of device could be utilized, such as rotary switches, a QWERTY keyboard, toggle switches, a joystick, an operator touch screen input arrangement, or the like—just to name a few nonlimiting examples.

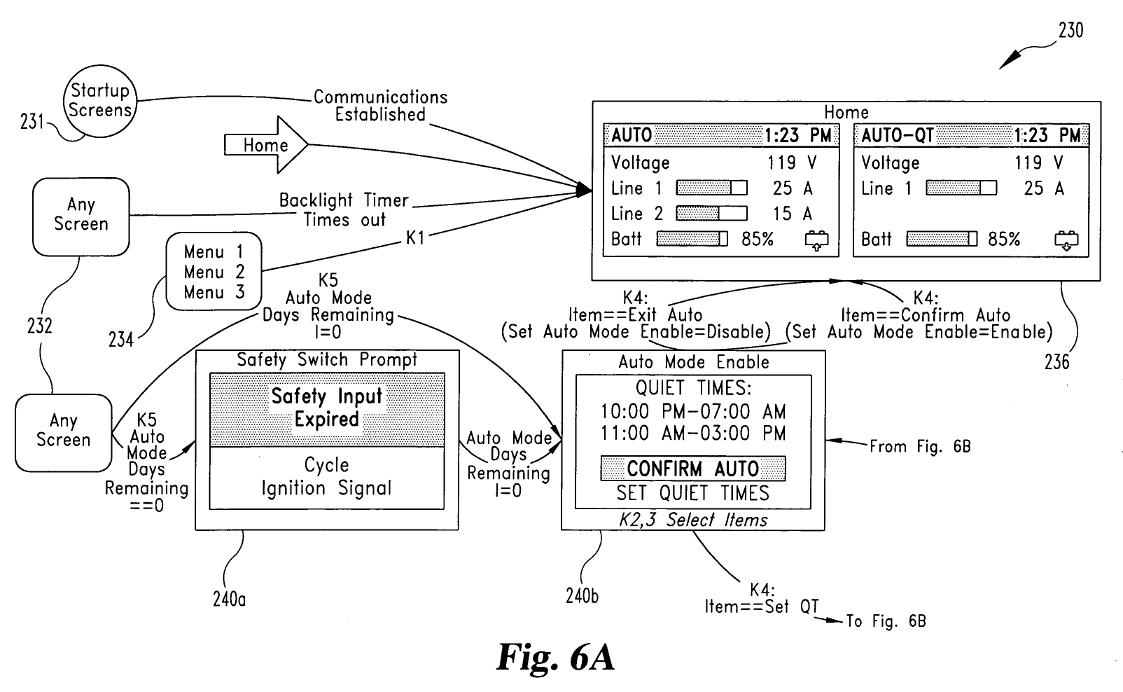

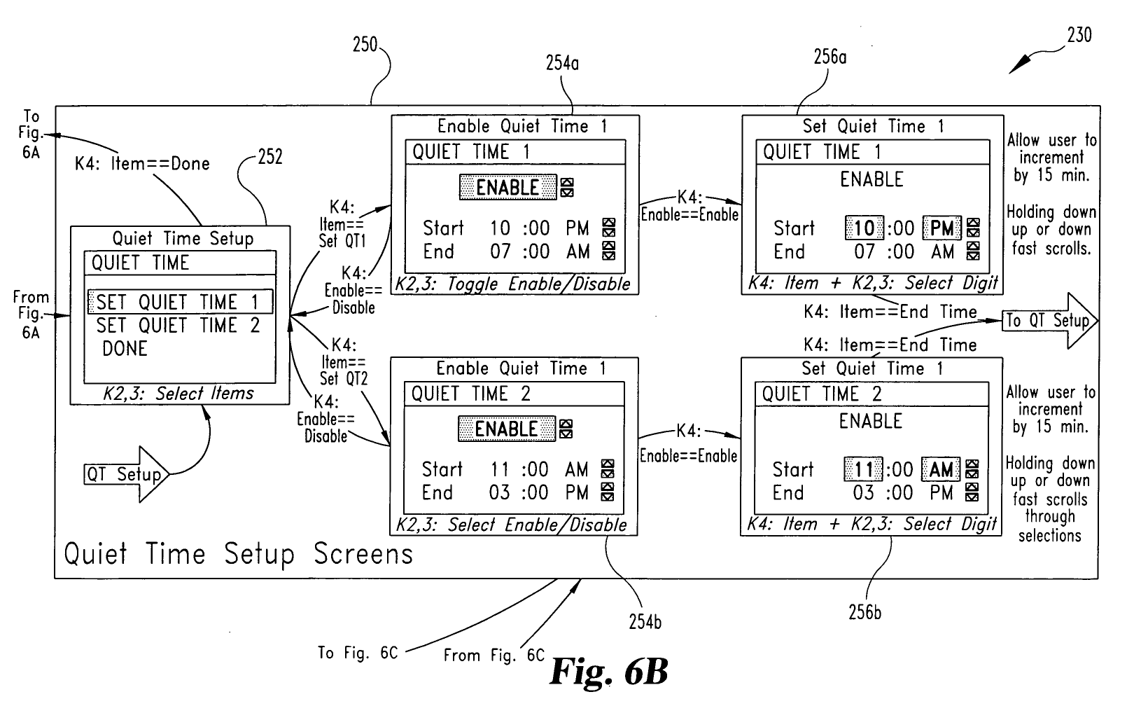

Through interface 115, an operator can direct a number of operations of system 20 and view the status of selected aspects of system 20. In connection with FIGS. 6-11, screen state logic diagrams are provided to illustrate the interaction between different sets of screen information presented on display device 215 and the activation of keys K1-K8 as embodied in interface control logic 230. Logic 230 can be included in the operating logic of processor 100 or at least partially provided by different processing device(s) for interface 115 (not shown), and may be in the form of software, firmware, hardware, or a combination of these. Generally, logic 230 is executed in response to the depression of keys K1-K8 and status data. Referring to FIG. 6 specifically, interface 115 is initialized and startup screens 231 are presented on device 215. Startup screens 231 may include the display of information related to the initialization of the processor, programming, and establishment of communications. Once communications have been established, a home screen state 236 is presented on device 215. Home screen state 236 is the default screen and may be reached from any screen state 232 by allowing a backlight timer (not shown) to time out. Home screen state 236 displays categories of information that include: the mode of operation (manual or auto), the time, and electrical parameters of system 28. For example, bus 80 voltage and current level and charge/boost status can be shown. As depicted, two alternative home screens are shown for the auto mode and the auto mode during quiet time (QT). For the auto mode (not QT), a graphic upward arrow overlaying a battery symbol indicates charging is taking place (85% charged), with two separate power supply circuits (Line1 and Line2) being active (at 25A and 15A, respectively). For the auto-QT mode, only one power supply circuit (Line1) is active at 25A, and power is sourced from the battery 75 (again 85% charge level is depicted) with the graphic arrow direction pointed downward to indicate that the battery 75 is being drained. It should be appreciated that other data may be displayed by home screen state 236 in other embodiments.

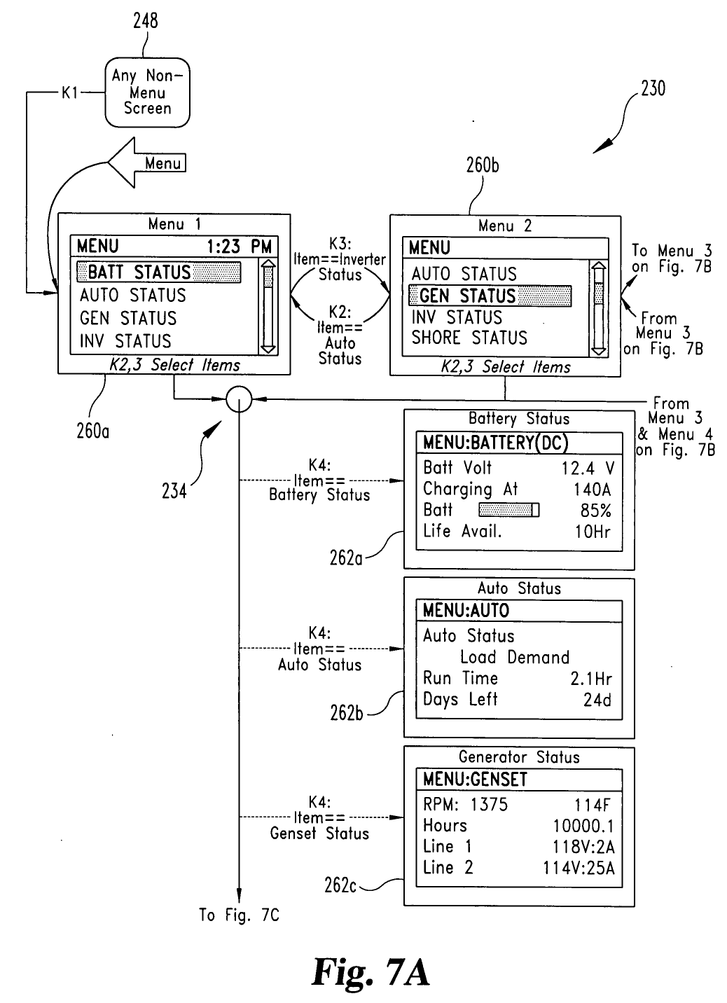

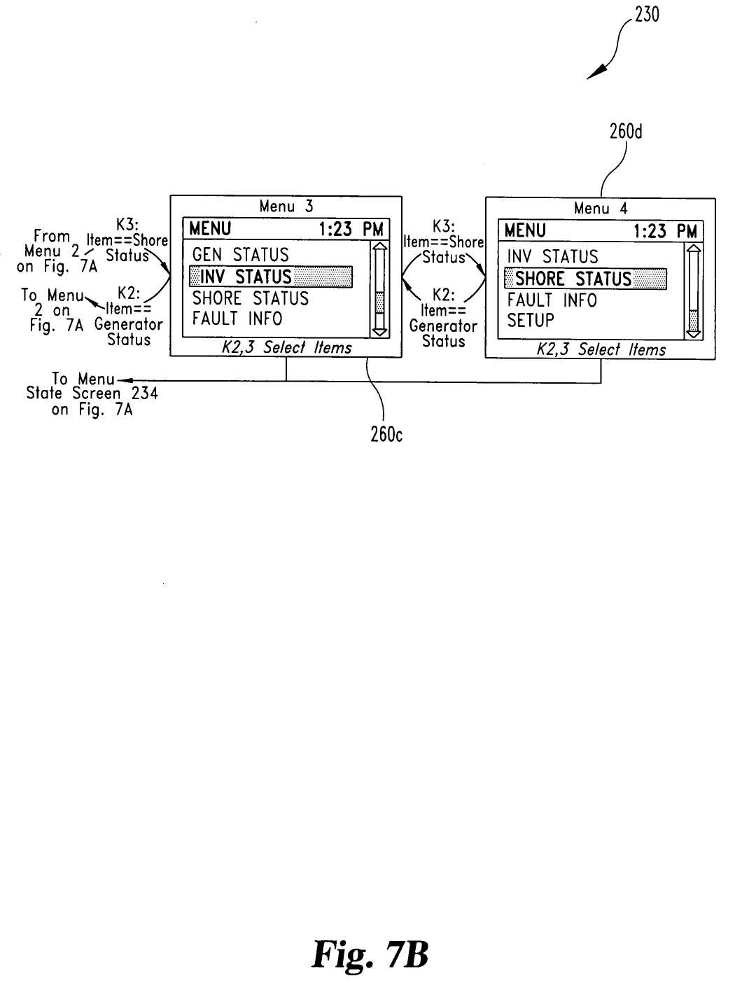

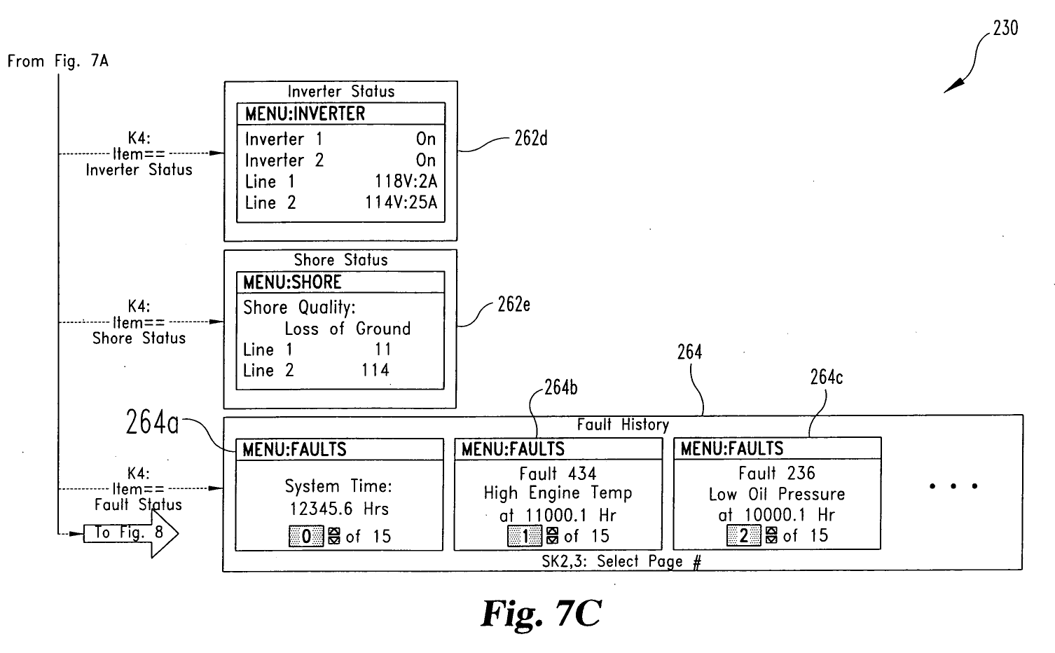

When home screen state 236 is presented on device 215 and key K1 is pressed, home screen state 236 is replaced with a menu screen state 234. Menu screen state 234 is further described in connection with FIG. 7. It should be appreciated that pressing key K1 when any non-menu screen state 248 is presented on device 215 replaces non-menu screen state 248 with menu screen state 234. It should also be appreciated that pressing key K1 when any menu screen state 234 is presented on device 215 replaces menu screen state 234 with home screen state 236; accordingly, pressing key K1 toggles between the home state screen 236 and menu state screen 234.

Menu screen state 234 includes selectable options that are displayed over a series of menu screens including menu one screen 260a, menu two screen 260b, menu three screen 260c, and menu four screen 260d, as shown in FIG. 7. The selectable options include: BATT(ery) STATUS, AUTO STATUS, GEN(set) STATUS, INV(erter) STATUS, SHORE (power) STATUS, FAULT INFO(rmation), and SETUP. It should be appreciated that other options may be included. Selection of an option is accomplished by pressing key K2 and/or key K3 incrementally to scroll up or down, highlighting a desired option and then pressing key K4 (OK) to select the highlighted option.

Each option listed on menu one screen 260a, menu two screen 260b, menu three screen 260c, and menu four screen 260d is associated with a screen displaying status information about the selected option. When the BATT(ery) STATUS option is selected, a battery status screen 262a is presented on device 215. Battery status screen 262a displays categories of information that include: the voltage of battery 75 (12.4V), the amount of current entering or exiting battery 75 (140A), the percent charge remaining in battery 75 (85% charged), and the amount of time that battery 75 can supply power before needing to be recharged (10 Hr).

When the AUTO STATUS option is selected, an auto status screen 262b is presented on device 215. Auto status screen 262b displays categories of information that include: a brief description of the status of the auto mode, the amount of time the auto mode has been running (2.1 Hr), and the number of days remaining that the auto mode has left to run (24d). The brief auto status description may be one of: standby, quiet time, disabled, low batt(ery), shore (power) overload, batt(ery) overload, and load demand.

When the GEN(set) STATUS option is selected, a generator status screen 262c is presented on device 215. Generator status screen 262c displays categories of information that include: the rotational speed of generator 34 in revolutions per minute (RPM) (as depicted 1375 RPM), the temperature of genset 30 (1140 F), the number of hours that genset 30 has operated (10000.1 hours), and the voltage and current (2A and 25A) on the two active power supply circuits (Line1 and Line2) supplied by genset 30.

When the INV(erter) STATUS option is selected, an inverter status screen 262d is presented on device 215. Inverter status screen 262d displays categories of information that include: the status (ON or OFF) of any inverters (depicted as dual inverters Inverter1 and Inverter2), and the voltage and current for the power supply circuits (Line1 and Line2) of bus 80. While only one inverter 46 has been illustrated in connection with system 28, it should be appreciated that logic 230 has been configured for optional application to multiple inverter configurations sometimes desired to deliver more power. In one such alternative, more than one rectifier/DC bus/inverter circuit is provided to convert electricity from a variable speed generator to a fixed frequency electric output. For one particular implementation, the generator is constructed with two isolated three-phase outputs that each supply electricity to a different inverter circuit, but the same engine serves as the prime mover. When multiple rectifier/DC bus/inverter circuits are used in this manner, some or all may include a charge/boost circuitry operating through the corresponding DC bus.

When the SHORE (power) STATUS option is selected, a shore status screen 262e is presented on device 215. Shore status screen 262e displays categories of status information that include: a brief description of quality/connection integrity, and the voltage and current on the power supply circuits (Line1 and Line2). The brief description of the connection quality may be one of: not detected, overfrequency, underfrequency, loss of ground, reverse polarity, high voltage, low voltage, loss of neutral, and good (Shore Available).

When the FAULT INFO(rmation) option is selected, a fault history screen state 264 is presented on device 215. State 264 displays information about a selected fault, including: the number of the fault, a brief description of fault, the time the fault occurred, the current screen number, and the total number of screens. A number of fault history screens are preserved in chronological order from most recent to least recent. Key K2 and key K3 are pressed to incrementally scroll up or down, highlighting the number of the desired fault history to display; and key K4 (OK) is pressed to select the highlighted number.

FIG. 7 illustrates fault history screen state 264 as preserving a total of sixteen fault history screens numbered zero to fifteen with fault one screen 264a being number zero of sixteen, fault two screen 264b being number one of sixteen, and fault three screen 264c being numbered two of sixteen. It should be appreciated that there may be more or less fault histories in other embodiments. Fault one screen 264a is the first of fault histories, and displays the total time the system has been running (12345.6 Hrs), a fault history number (0), and the total number of fault histories (15 in this case). Fault two screen 264b displays information corresponding to fault number 434 for high engine temperature, the time the fault occurred (at 11000.1 Hr), a fault history number (1), and the total number of fault histories. Fault three screen 264c displays information corresponding to fault number 236 for low oil pressure, the time the fault occurred (10000.1 Hr), a fault history number (2), and the total number of fault histories.

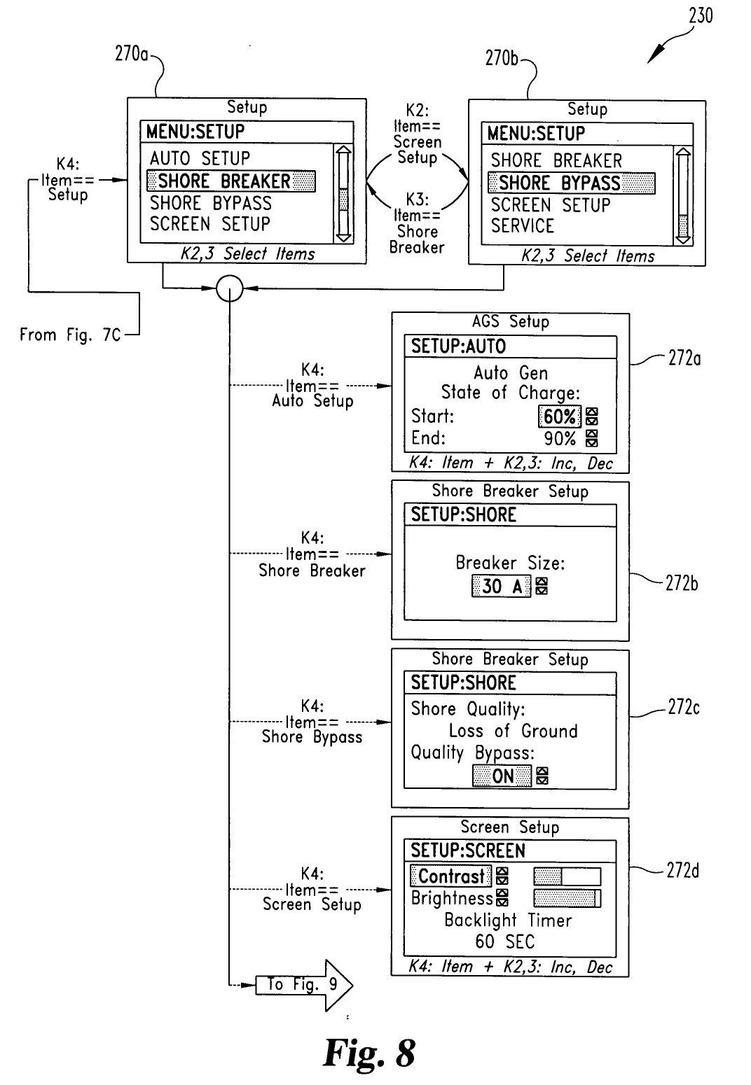

When the SETUP option is selected, setup menu screens 270a and 270b are presented on device 215 as shown in FIG. 8. Setup menu screens 270a and 270b include selectable options that are displayed thereon. The selectable options include: AUTO SETUP, SHORE BREAKER, SHORE (power) BYPASS, SCREEN SETUP, and SERVICE. Toggling from screen 270a to screen 270b results when key K2 increments to “SETUP SCREEN” and from screen 270b back to screen 270a when key K3 increments to “SHORE BREAKER.”

When the AUTO SETUP option is selected, an auto setup screen 272a is presented on device 215. Auto setup screen 272a displays categories of information relating to charging of battery 75 by genset 30 during auto mode that include: a percent charge in battery 75 (60%) to start charging, and a percent charge in battery 75 (90%) above which charging can end. The “Start” and “End” percent charge values may be changed by pressing key K2 and/or key K3 to incrementally scroll up or down to highlight the desired category; pressing key K4 (OK) to select the highlighted category; pressing key K2 and key K3 to incrementally scroll up or down between the values 40%, 50%, 60%, and 70% for the “Start” category, and 80%, 90%, and 100% for the “End” category; and pressing key K4 (OK) to select the value.

When the SHORE BREAKER option is selected, a shore setup screen 272b is presented on device 215. Shore setup screen 272b displays a category of information relating to the maximum amount of current (Breaker Size) the shore breaker (not shown) is rated for (depicted as 30A in this example). The rating may be changed by pressing key K2 and/or key K3 to incrementally increase or decrease the rating; and pressing key K4 (OK) to select the new rating.

When the SHORE BYPASS option is selected, a shore quality setup screen 272c is presented on device 215. Shore quality setup screen 272c displays categories of information that include: a brief description of the quality of the connection between system 20 and shore power source 90, and the status of a bypass to use shore power regardless of shore power conditions. The brief description of the connection quality may include: not detected, overfrequency, underfrequency, loss of ground, reverse polarity, high voltage, low voltage, loss of neutral, and good (Shore Available). The status of the bypass may be changed between “ON” and “OFF” by pressing key K2 and/or key K3 to highlight “ON” or “OFF;” and pressing key K4 to select the new status.

When the SCREEN SETUP option is selected, a display setup screen 272d is presented on device 215. Display setup screen 272d displays categories of information that include: the contrast, brightness, and backlight time limit (60 seconds is shown). The contrast and brightness levels may be raised or lowered by pressing key K2 and/or key K3 to incrementally scroll up or down, highlighting the desired category; pressing down key K4 (OK) to select the category; pressing key K2 and/or key K3 to incrementally increase or decrease the contrast or brightness levels; and pressing key K4 (OK) to select the new level. The backlight timer limit may be changed from “OFF” to a different time period by pressing key K2 and/or key K3 to incrementally increase or decrease the time limit, and pressing key K4 (OK) to select the new time limit.

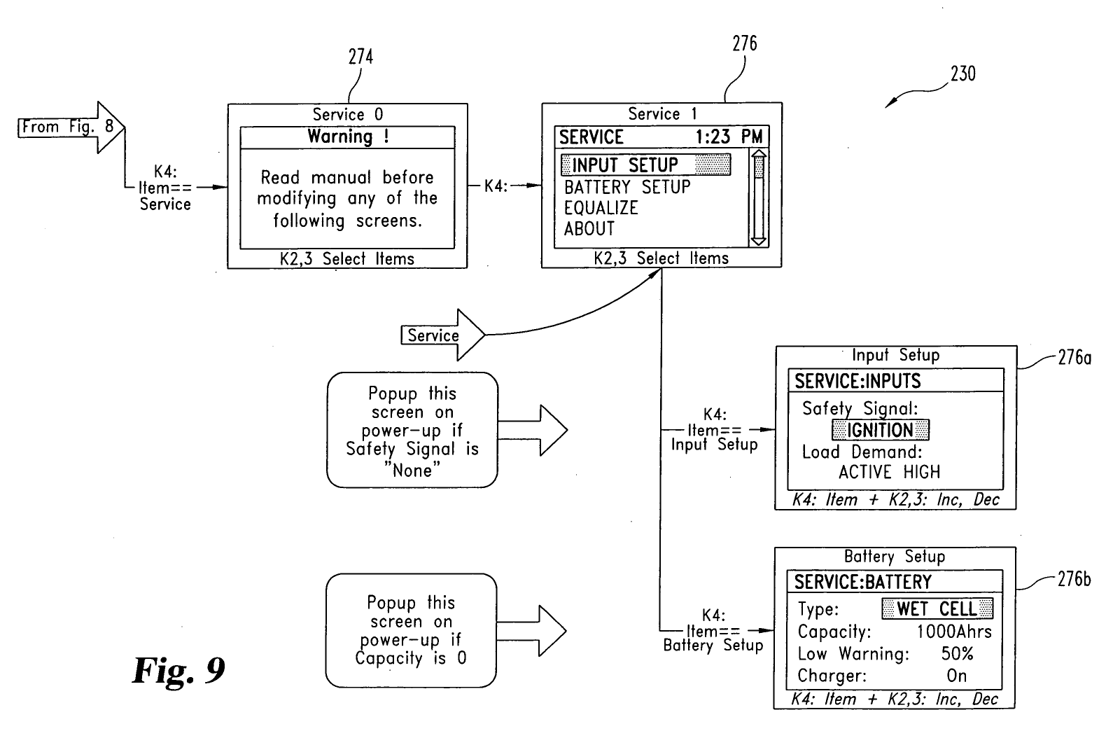

When the SERVICE option is selected, a warning screen 274 is presented on device 215, as shown in FIG. 9. Warning screen 274 displays a warning to the operator that they should read the manual before attempting to modify any of the following screens. Key K4 (OK) is pressed to proceed from warning screen 274 to service setup menu screen 276. Service setup menu screen 276 displays selectable options that include: INPUT SETUP, BATTERY SETUP, EQUALIZE, and ABOUT.

When the INPUT SETUP option is selected, an input setup screen 276a is presented on device 215. Input setup screen 276a displays categories of information that include: the safety signal and the load demand (Active High or Active Low). The safety signal may be one of: Brake, Ignition, Park, or None. The safety signal may be changed by pressing key K2 and/or key K3 to incrementally scroll up or down, highlighting the desired category; pressing key K4 (OK) to select the category; pressing key K2 and/or key K3 to incrementally scroll up or down, highlighting the desired safety signal; and pressing key K4 (OK) to select the new safety signal. If the safety signal is set to “None,” input setup screen 276a is presented on device 215 when interface 115 is powered on. When selected, the given type of safety signal must be cycled before the auto mode can be re-enabled, after a predefined number of days operating in the auto mode expires. The auto mode is further described hereinafter.

When the BATTERY SETUP option is selected, a battery setup screen 276b is presented on device 215. Battery setup screen 276b displays categories of information including: the battery type, the capacity of the battery (1000 Ahrs), the percent charge remaining in the battery that will signal when the battery is low (50%), and the status of the charger (ON or OFF). The battery type can also be specified, such as Wet Cell, Gel, AGM, or Custom, to name a few examples. This selection can be made by pressing key K2 and/or key K3 to incrementally scroll up or down, highlighting the desired category; and pressing key K4 (OK) to select the battery type. If the capacity of the battery is set to zero (0 Ahrs), battery setup screen 276b is presented on device 215 when interface 115 is powered on.

The EQUALIZE option relates to the setup of certain battery charging aspects. The selection of this entry with key K4 results in one of several screens being present and depending on various parameters.

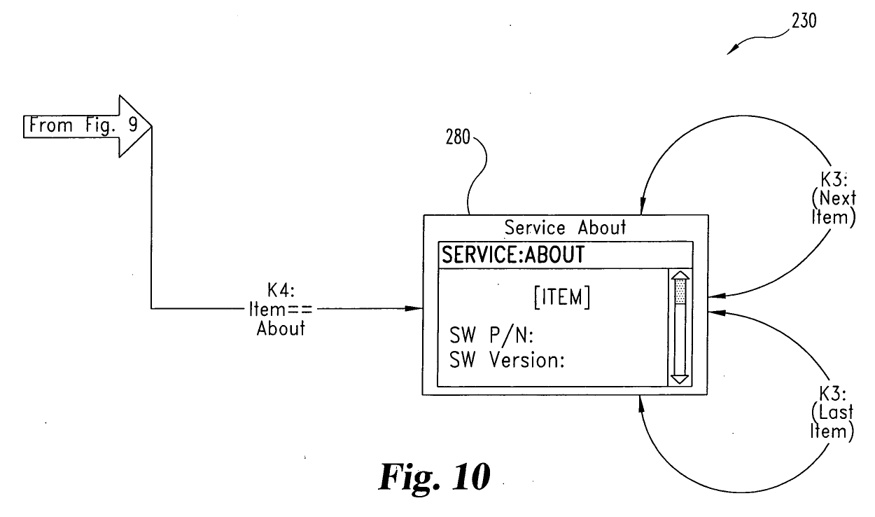

When the “ABOUT” option is selected, an about service screen 280 is presented on device 215, as shown in FIG. 10. About service screen 280 may display information relating to multiple aspects of system 28. Some of the information may include: a brief description of an item ([Item]), the part number (SW P/N), and the version (SW Version). An operator may view the “ABOUT” information for other items by pressing key K2 and/or key K3 to advance to the next item or to the previous item, respectively.

Returning to FIG. 6, the auto mode of system operation is selected by pressing key K5 from any screen state 232. In response, the auto mode safety switch prompt 240a is displayed when the number of days remaining for the auto mode to be active is zero. Alternatively, an auto mode enable screen 240b is displayed when the number of days remaining is greater than zero. Auto mode switch prompt 240a notifies the user that the safety input has expired. To continue with auto mode operation, the applicable safety signal set via screen 276a (FIG. 9) needs to be recycled if one is installed.

Auto mode enable screen 240b displays a plurality of quiet time ranges (10:00 PM-07:00 AM and 11:00 AM-03:00 PM are depicted) over which the genset 30 is inactive. Also screen 240b includes options: (1) CONFIRM AUTO (depicted) or EXIT AUTO (not depicted), and (2) SET QUIET TIMES. CONFIRM AUTO is displayed if auto mode is currently enabled and EXIT AUTO is displayed if auto mode is currently disabled.

When the SET QUIET TIMES option is selected, a quiet time setup 250 is entered and a quiet time menu 252 is presented on device 215, as shown in FIG. 6. Quiet time menu 252 displays selectable options that include: SET QUIET TIME 1, SET QUIET TIME 2, and DONE. When the set quiet time 1 option is selected, a quiet time 1 enable screen 254a is presented on device 215. Quiet time 1 enable screen 254a displays categories of information that includes: the quiet time status (Enable or Disable), the beginning (Start) of the quiet time period (10:00 PM), and the end (End) of the quiet time period (07:00 AM). The quiet time status may be changed by pressing key K2 and/or key K3 to incrementally scroll up or down, highlighting the desired status; and pressing key K4 (OK) to select the status.

When quiet time 1 is enabled, a quiet time 1 setup screen 256a is presented on device 215. Quiet time 1 setup screen 256a displays categories of information that include: the beginning (Start) of the quiet time period (10:00 PM) and the end (End) of the quiet time period (07:00 AM). The times may be changed by pressing key K2 and/or key K3 to incrementally scroll up or down, highlighting the desired category; pressing key K2 and/or key K3 to incrementally increase or decrease the hours or minutes.

When the SET QUIET TIME 2 option is selected, a quiet time 2 enable screen 254b is presented on device 215. Quiet time 2 enable screen 254b displays categories of information that include: the quiet time status (Enable or Disable), the beginning (Start) of the quiet time period (11:00 PM), and the end (End) of the quiet time period (03:00 AM). The quiet time Enable/disable status can be changed in the same manner as described for screen 254a; and the corresponding time internal adjusted via screen 256b the same as for screen 256a. Screens 256a and 256b return to screen 252. When DONE is selected in screen 252 with key K4, logic 230 returns to screen 240b. With the selection of CONFIRM AUTO via key K4, logic 230 returns to the home screen state 236 with auto mode enabled. With the selection of EXIT AUTO with key K4, logic 230 returns to the home screen state 236 with auto mode disabled.

From any screen state 232, the manual control mode screen 242 is reached by pressing key K6. Manual control mode screen 242 displays selectable options that include: TURN ALL OFF (or ON), TURN INV(erter) OFF (or ON), TURN GEN(set) ON (or OFF), and EXIT AUTO MODE. It should be appreciated that the displayed option (ON/OFF) is the opposite of the current operational status (OFF/ON) with regard to screen 242. Similarly, selection of the EXIT AUTO MODE option toggles its status from enable to disable. It should be appreciated that screen 242 provides the operator independent control over the genset 30 and inverter 46. In contrast, when operating in auto mode, genset 30 and inverter 46 are activated automatically based on the auto mode configuration as defined by quiet times, charging parameters, shore power settings, and the like.

Pressing key K8 from any screen state 232 presents clock setup screen 244 on device 215. Clock setup screen 244 displays the current time and related options. The selectable options include: SET CURRENT TIME and SET QUIET TIMES. When the set quiet time option is selected, quiet time setup 250 is entered and quiet time menu 252 is presented on device 215, as previously described.

When the SET CURRENT TIME option is selected, a current time setup screen 246 is presented on device 215. Current time setup screen 246 displays categories of information that allow the operator to change the hour, minute, and the time period designation (AM or PM). The time may be changed by pressing key K2 and/or key K3 to incrementally scroll up or down, highlighting the hour or minute category; pressing key K4 (OK) to select the category; pressing key K2 and/or key K3 to incrementally increase or decrease the hours or minutes; pressing key K4 (OK) to select the time period designation category; pressing key K2 and/or key K3 to incrementally scroll up or down, highlighting the desired time period designation; and pressing key K4 (OK) to select the hours or minutes and return the operator to the quiet time menu 252. It should be appreciated that holding down key K2 or key K3 rapidly increments the hours or minutes.

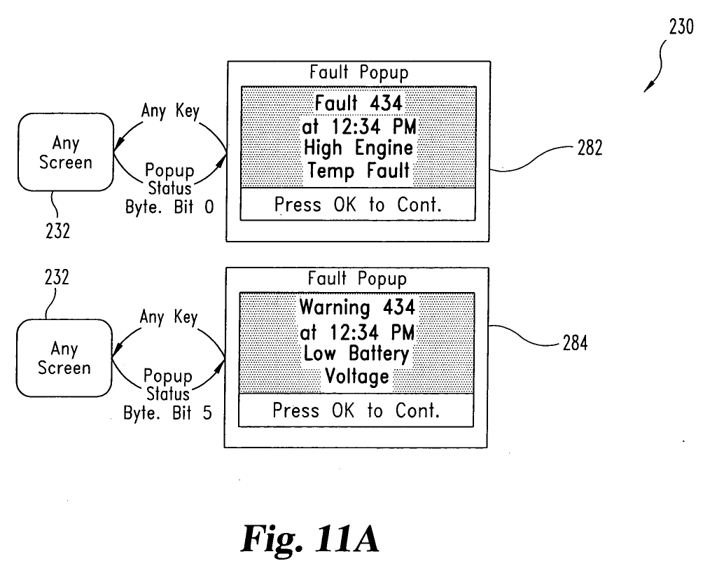

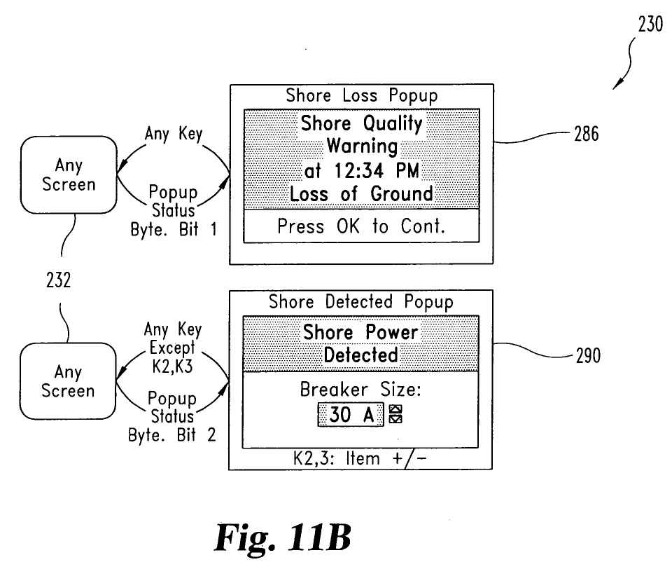

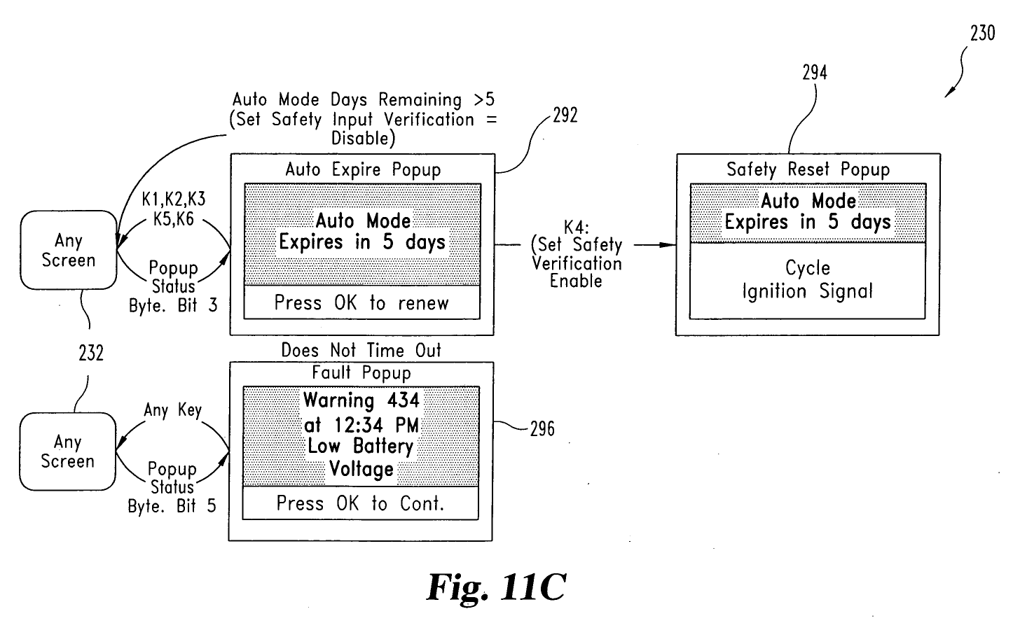

Popup screens may replace any screen state 232 presented on device 215 at any time. One popup screen is fault detected popup 282, as shown in FIG. 11. Fault detected popup 282 displays categories of information that include: the number of the fault (Fault 434), the time the fault occurred (at 12:34 PM), and a brief description of the fault (High Engine Temp Fault). Fault detected popup 282 does not automatically time out and return to the previous screen presented on device 215. Any of keys K1-K8 must be pressed to return to the previously displayed screen.

Another popup screen is fault warning popup 284. Fault warning popup 284 displays categories of information that include: the number of the warning (Fault 434), the time the warning occurred (at 12:34), and a brief description of the warning (Low Battery Voltage). Fault warning popup 284 automatically times out after 10 minutes and returns to the previous screen presented on device 215 unless any of keys K1-K8 is pressed first, which causes the previously displayed screen to be presented on device 215.

Yet another popup screen is shore power quality warning popup 286. Shore power quality warning popup 286 displays categories of information that include: the type of warning (Shore Quality Warning), the time the warning occurred (at 12:34 PM), and a brief description of the warning. The brief description of the warning may include: overfrequency, underfrequency, loss of ground, reverse polarity, high voltage, and low voltage. Shore power quality warning popup 286 does not automatically time out. Any of keys K1-K8 must be pressed to return to the previously displayed screen.

Still another popup screen is shore power detected popup 290. Shore power detected popup 290 displays categories of information that include: the detection of shore power (Shore Power Detected) and the maximum amount (Breaker Size) of current the shore breaker is rated for (30A). The rating may be any one of: 15A, 20A, 30A, or 50A. The rating may be changed by pressing key K2 and/or key K3 to incrementally scroll up or down, highlighting the desired rating; and pressing key K4 (OK) to select the rating. Shore power quality detected popup 290 automatically times out after 10 minutes and returns to the previous screen presented on device 215 unless any of keys K1-K8 is pressed first, which causes the previously displayed screen to be presented on device 215.

A further popup screen is auto mode expiration warning popup 292. Auto mode expiration warning popup 292 is presented on device 215 when the number of days remaining for the auto mode to run is five or less. Auto mode expiration warning popup 292 displays categories of information that include: the number of days the auto mode has left to run (Auto Mode Expires in 5 days) and a renewal option (Press OK to renew). The auto mode may be renewed by pressing key K4 (OK). Auto mode expiration warning popup 292 does not automatically time out. Any of keys K1-K3 and K5-K8 must be pressed first to return to the previously displayed screen.

Still another popup screen is safety reset popup 294. Safety rest popup 294 is presented on device 215 when the number of days remaining for the auto mode to run is greater than five, or when key K4 is pressed to renew the auto mode on auto mode expiration warning popup 292. Safety rest popup 294 displays: the number of days the auto mode has left to run (Auto Mode Expires in 5 days) and the safety signal to cycle (if installed). Different signal types include: cycle ignition signal, cycle brake signal, and cycle park signal, as well as not installed. Safety rest popup 294 automatically times out after a predetermined time set if no signal is received, and returns to the previous screen presented on device 215 unless any of keys K1 and K4-K8 is pressed first, which causes the previously displayed screen to be presented on device 215.

Yet another popup screen is safety expired popup 296. Safety expired popup 296 is presented on device 215 when there are no more days remaining for the auto mode to run. Safety expired popup 296 displays information relating to the expiration of the safety input (Safety Input Expired) and the end of the auto mode (Auto Mode Ended). The safety expired popup 296 automatically times out after a predefined period and returns to the previous screen presented on device 215 unless any of keys K1 and K4-K8 are pressed first, which causes the previously displayed screen to be presented on device 215.

In other embodiments, more or fewer operator screens are provided, the screens may be differently organized, the navigation and connectivity between screens may differ, the information displayed (output) and inputs offered may differ, and/or different operating mode options may be included.

Many other embodiments of the present application exist. For example, one or more fuel cell devices, capacitive-based storage devices, and/or a different form of rechargeable electrical energy storage apparatus could be used as an alternative or addition to an electrochemical cell or battery type of storage device 70. Furthermore, one or more fuel cells (including but not limited to a hydrogen/oxygen reactant type) could be used to provide some or all of the power from genset 30 and/or energy storage device 70. Engine 32 can be gasoline, diesel, gaseous, or hybrid fueled; or fueled in a different manner as would occur to those skilled in the art. Further, it should be appreciated that engine 32 can be different than a reciprocating piston, intermittent combustion type, and/or coach engine 26 can be used in lieu of engine 32 to provide mechanical power to generator 34 or to supplement mechanical power provided by engine 32. In still another embodiment, the vehicle carrying system 28 is a marine vessel. In one variation of this embodiment, rotational mechanical power for generator 34 is provided from a propulsion shaft (such as a propeller shaft) with or without engine 32. Alternatively or additionally, generator 34 can be of a different type, including, but not limited to a wound field alternator, or the like with adaptation of circuitry/control to accommodate such different generator type, as desired.

Another example comprises: carrying a mobile electric power generation system with a vehicle that includes a variable speed generator, an electrochemical battery, an inverter coupled to the generator and the battery through a DC bus, and an operator interface with two or more operator input devices; selecting an automatic mode of system operation with one of the operator input devices; in response to the selecting of the automatic mode, controlling system operation in an automatic mode that includes activating operation of both the generator and the inverter; switching from the automatic mode to manual control of the system with the interface; and during manual control of the system, changing the operating state of the generator and the inverter with one or more other of the operator input devices.

Yet another embodiment includes a mobile electric power generation system having a variable speed generator, an engine to drive the generator, a DC bus coupled to the generator, an inverter coupled between the DC bus and an electrical power bus in the vehicle, an electrical energy storage device coupled to the DC bus, an operator interface including a display and several operator input devices, and operating logic executed by a processor. One of the operator input devices is selected by an operator to initiate an automatic mode of operation of the system. The operating logic is structured to activate both the generator and the inverter during the automatic mode of operation. Another of the operator input devices is selected by the operator to initiate a manual mode of operation of the system. The operating logic is responsive to a first type of input during the manual mode of operation to change activation of the generator and to a second type of input during the manual mode of operation to change activation of the inverter.

Still another embodiment comprises: carrying a mobile electric power generation system with a vehicle, the system includes an operator interface with a display device and two or more operator input devices, control logic to control system operation, and several system power components, the system power components including a variable speed generator, an electrochemical battery, and an inverter coupled to the generator and the battery through a DC bus; selecting between an automatic mode and a manual mode of system operation with at least one of the operator input devices, the automatic mode providing for control of the system components in accordance with an automatic operating protocol defined by the control logic, and the manual mode providing for operator activation and deactivation of one of the components separate from other of the components; and with the display device, displaying one or more menus including a number of operator status display options and a number of operator setup options each selectable with one or more other of the input devices.

A further embodiment includes a mobile electric power generation system for a vehicle. This system comprises a variable speed genset, an electric chemical battery, an inverter coupled to the genset and the battery through a DC bus, and an operator interface with two or more operator input devices. The system also includes means for selecting an automatic mode of system operation with one of the operator input devices, means for controlling system operation in an automatic mode that includes activating both the genset and the inverter in response to automatic mode selection, means for switching from the automatic mode to manual control of the system with the interface, and means for changing operating state of the genset and inverter with one or more other of the operator input devices during manual control of the system.

Yet a further embodiment includes a mobile electric power generation system for a vehicle that has an operator interface with a display and two or more operator input devices, control logic to control system operation, and several power system components. These components include a variable speed genset, an electric chemical battery, and an inverter coupled to the genset in the battery through a DC bus. Also included are means for selecting between an automatic mode and a manual mode of system operation with at least one of the operator input devices, with the automatic mode providing for control of the system components in accordance with an automatic operating protocol defined by the control logic and the manual mode providing for operator activation and deactivation of one of the components separate from other of the components, and means for displaying one or more menus including a number of operator status display options and a number of operator setup options each selectable with one or more other of the input devices.

Any theory, mechanism of operation, proof, or finding stated herein is meant to further enhance understanding of the present invention and is not intended to make the present invention in any way dependent upon such theory, mechanism of operation, proof, or finding. It should be understood that while the use of the word preferable, preferably or preferred in the description above indicates that the feature so described may be more desirable, it nonetheless may not be necessary and embodiments lacking the same may be contemplated as within the scope of the invention, that scope being defined by the claims that follow. In reading the claims it is intended that when words such as “a,” “an,” “at least one,” “at least a portion” are used there is no intention to limit the claim to only one item unless specifically stated to the contrary in the claim. Further, when the language “at least a portion” and/or “a portion” is used the item may include a portion and/or the entire item unless specifically stated to the contrary. While the invention has been illustrated and described in detail in the drawings and foregoing description, the same is to be considered as illustrative and not restrictive in character, it being understood that only the selected embodiments have been shown and described and that all changes, modifications and equivalents that come within the spirit of the invention as defined herein or by any of the following claims are desired to be protected.

What is claimed is:

1. A method, comprising:
carrying a mobile electric power generation system with a vehicle, the system including a variable speed genset, an electrochemical battery, an inverter coupled to the genset and the battery through a DC bus, and an operator interface with two or more operator input devices;
selecting an automatic mode of system operation with one of the operator input devices;
in response to the selecting of the automatic mode, controlling system operation in an automatic mode that includes activating operation of both the genset and the inverter;
switching from the automatic mode to manual control of the system with the interface; and
during the manual control of the system, changing operating state of the genset and the inverter with one or more other of the operator input devices.

2. The method of claim 1, wherein the system includes a transfer switch coupled to a power bus for the vehicle and route shore power from a source external to the vehicle or power output from the inverter to the power bus and further comprising displaying information about shore power through the transfer switch with the interface.

3. The method of claim 1, wherein the controlling of the system operation in the automatic mode includes activating and deactivating the genset each day in accordance with a schedule defining one or more time segments to provide power from the battery while the genset is deactivated.

4. The method of claim 1, wherein the operator interface includes a display device, and further comprising:
displaying a menu with the display device;
presenting a number of status display options with the menu; and
selecting one of the status display options with an input through the interface.

5. The method of claim 1, wherein the operator interface includes a display device, and further comprising:
displaying a menu with the display device;
presenting a number of system setup display options with the menu; and
selecting one of the system setup display options with an input through the interface.

6. The method of claim 1, which includes indicating one or more system faults through the operator interface.

7. The method of claim 1, which includes confirming selection of the automatic mode with input from another of the operator input devices.

8. The method of claim 1, which includes conditioning automatic mode operation on a safety time period spanning one or more days unless a reset signal is detected.

9. An apparatus, comprising:
a mobile electric power generation system including a variable speed generator, an engine to drive the generator, a DC bus coupled to the generator, an inverter coupled between the DC bus and an electrical power bus in the vehicle, an electrical energy storage device coupled to the DC bus, an operator interface including a display and several operator input devices, and operating logic executed by a processor;
a first one of the operator input devices being selected by an operator to initiate an automatic mode of operation of the system, the operating logic being structured to activate both the generator and the inverter during the automatic mode of operation; and
a second one of the operator input devices being selected by the operator to initiate a manual mode of operation of the system, the operating logic being responsive to a first type of input during the manual mode of operation to change activation of the generator and to a second type of input during the manual mode of operation to change activation of the inverter.

10. The apparatus of claim 9, further comprising a vehicle carrying the system, the system including a power transfer switch to selectively route power to a vehicle power bus from a shore power source external to the vehicle or the inverter.

11. The apparatus of claim 9, wherein the operator input devices are each a key switch and the display is of an LCD type.

12. The apparatus of claim 9, wherein the operating logic includes means for operating the system in accordance with a schedule including one or more quiet time segments each day during the automatic mode of operation.

13. The apparatus of claim 9, further comprising means for displaying a menu with a number of different displayable status options and means for displaying a menu with a number of different displayable setup options.

14. The apparatus of claim 9, wherein the operator interface includes a number of indicators, a first one of the indicators indicating activation state of the genset, and a second one of the indicators indicating activation state of the inverter.

15. The apparatus of claim 9, wherein the first one of the operator input devices is dedicated to initiation of the automatic mode, the second one of the operator input devices is dedicated to initiation of the manual mode, a third one of the operator input devices is dedicated to displaying a list of selections, at least a fourth one of the operator input devices is dedicated to scrolling through the list of selections, and a fifth one of the operator input devices is dedicated to selecting one entry of the list of selections.

16. A method, comprising:
carrying a mobile electric power generation system with a vehicle, the system includes an operator interface with a display device and two or more operator input devices, control logic to control system operation, and several system power components, the system power components including a variable speed genset, an electrochemical battery, and an inverter coupled to the genset and the battery through a DC bus;
selecting between an automatic mode and a manual mode of system operation with at least one of the operator input devices, the automatic mode providing for control of the system components in accordance with an automatic operating protocol defined by the control logic, and the manual mode providing for operator activation and deactivation of one of the components separate from other of the components; and
with the display device, displaying one or more menus including a number of operator status display options and a number of operator setup options each selectable with one or more other of the input devices.

17. The method of claim 16, wherein the system power components further include a power transfer switch to selectively route power to a vehicle power bus from the inverter or shore power from a source external to the vehicle.

18. The method of claim 17, wherein the operator input devices are each a key switch, the display device is of an LCD type, and the operator interface includes a number of indicators, a first one of the indicators represents activation state of the genset, a second one of the indicators represents activation state of the inverter, a third one of the indicators represents activation state of the automatic mode, and a fourth one of the indicators represents activation state of the shore power.

19. The method of claim 16, wherein the automatic mode includes operating the system in accordance with a schedule including one or more quiet time segments each day, the genset being deactivated during each of the one or more quiet time segments while power is provided from the battery.

20. The method of claim 16, wherein the automatic mode includes activating both the genset and the inverter and the manual mode includes activating the genset and the inverter independent of one another.

21. The method of claim 20, wherein the status display options includes a one option to display status of the genset and another option to display status of the inverter.

22. A method, comprising:
carrying a mobile electric power generation system with a vehicle, the system including an internal power source, a power interface to selectively couple to an external power source, and control logic to control system operation, the control logic defining an automatic mode to operate the system in accordance with an automatic operating protocol and a manual mode to provide for operator activation and deactivation of different components of the system;
receiving electric power through the power interface from the external power source;
during the automatic mode, the control logic:
determining failure of the electric power from the external power source to satisfy one or more criteria corresponding to power quality; and
in response to the failure, switching from the external power source to the internal power source to provide the electric power to the vehicle.

23. The method of claim 22, wherein the internal power source includes a variable speed genset, an electrochemical battery, and an inverter coupled to a DC bus.

24. The method of claim 23, wherein the system includes an operator interface with a display device and one or more operator input devices, and further comprising selecting the automatic mode with the one or more operator input devices.

25. The method of claim 24, wherein the operator input devices are each a key switch, the display device is of an LCD type, and the operator interface includes a number of indicators, a first one of the indicators represents activation state of the genset, a second one of the indicators represents activation state of the inverter, a third one of the indicators represents activation state of the automatic mode, and a fourth one of the indicators represents status of external power sourcing through the power interface.

26. The method of claim 23, wherein the automatic mode includes activating both the genset and the inverter, and the manual mode includes activating the genset and the inverter independent of one another.

27. The method of claim 22, which includes routing the electric power to the vehicle through a power transfer switch coupled to the power interface and the internal power source.

28. The method of claim 22, wherein the automatic mode includes operating the system in accordance with a schedule including one or more quiet time segments each day, the genset being deactivated during each of the one or more quiet time segments while power is provided from the battery.
